(19) United States
(12) Patent Application Publication
(10) Pub. No.: US 2015/0137466 A1
(43) Pub. Date: May 21, 2015

(54) ATTENDED WHEELED VEHICLE WITH FRONT WHEEL STEERING

(71) Applicants: Edward Thomas Meree, Poquoson, VA (US); Marc Lukas Leber, Suffolk, VA (US)

(72) Inventors: Edward Thomas Meree, Poquoson, VA (US); Marc Lukas Leber, Suffolk, VA (US)

(21) Appl. No.: 14/082,112

(22) Filed: Nov. 16, 2013

(51) Int. Cl. B62B 3/00

(52) U.S. Cl. CPC B62B 3/001
USPC 280/47.11

(57) ABSTRACT

The invention provides a means of steering the front wheel of an attendant pushed wheeled vehicle by using independent levers; one lever to turn a front wheel right and one lever to turn left. The steering invention also allows for use of a fixed handle bar to efficiently propel the vehicle by an attendant.

| Citing Patent | Applicant | Title |
|---|---|---|
| U.S. Pat. No. 4,449,420 | Nippon Cable System Inc. | Steering apparatus |
| U.S. Pat. No. 4,840,076 | The University Of Virginia | Lever drive apparatus |
| | Alumni Patents Foundation | |
| U.S. Pat. No. 4,976,451 | Kamenov Kamen G | Human powered vehicle |
| U.S. Pat. No. 5,020,815 | Scott Orthotic Labs, Inc. | Self-propelled, steerable |
| | | wheelchair |
| U.S. Pat. No. 5,209,506 | Klopfenstein King L | Vehicle with combined |
| | | propulsion and steering |
| | | mechanism |
| U.S. Pat. No. 5,259,635 | Sherwood Drolet Corporation | Wheelchair |
| | Ltd | |
| U.S. Pat. No. 5,280,936 | Dennis Schmidlin | Human powered vehicle and |
| | | drive system |
| U.S. Pat. No. 5,690,346 | Keskitalo; Antti M. | Human powered drive- |
| | | mechanism with versatile |
| | | driving modes |
| U.S. Pat. No. 5,775,708 | Heath; Steven C. | Exercise vehicle with cable |
| | | steering system |
| U.S. Pat. No. 6,224,078 | Steven Tidcomb | Steering arrangement for an |
| | | occupant-propelled vehicle |
| U.S. Pat. No. 6,709,013 | University of Arkansas | Land vehicle with lever |
| | | steering |
| U.S. Pat. No. 6,764,089 | Robert Drymalski | Manually powered drive |
| | | mechanism and vehicle |
| | | employing same |
| U.S. Pat. No. 6,932,370 | Columbia-Inland Corporation | Human-powered, ride-on |
| | | vehicle |
| U.S. Pat. No. 7,066,480 | Sport System Engineering | System for controlling a |
| | | moving part, steering system |
| | | for a light vehicle and tricycle |
| | | fitted with said system |
| U.S. Pat. No. 7,195,264 | Robert Drymalski | Manually powered vehicle |
| | | having improved steering |
| U.S. Pat. No. 7,753,386 | Robert Drymalski | Steering mechanism and |
| | | method for a manually |
| | | powered vehicle |

### BACKGROUND OF THE INVENTION

The present invention relates to attendant manually powered vehicles. More particularly, the present invention relates to a manually powered steering mechanism. A simple system of levers, cables and springs are used in conjunction with a fixed handlebar system to maximize the efficiency of propelling the attended vehicle while providing additional steering capability. The fixed handle bar allows for more efficient pushing as a variety of hand and body positions can be used to reduce attendant fatigue.

Attendant pushed wheeled vehicles have been used for years to propel a person or persons. Examples include wheelchairs for disabled people or strollers for children. There are many different solutions to steering self-propelled or attendant propelled vehicles which speaks directly to the need for such an invention. The proposed invention is different from the steering mechanism of other existing inventions, some of which are:

U.S. Pat. No. 5,259,635 A is a self-propelled racing wheelchair. Embodiments of the steering system uses steering handles and a more complex cam and pinion system for steering.

U.S. Pat. No. 6,224,078 B2 is a self-propelled vehicle which uses a cable system in some embodiments. Rotation of front wheel(s) is accomplished by rotation of handles and more complex rack and pinion steering mechanism.

U.S. Pat. No. 6,709,013 B2 is a land vehicle with lever steering. This system for a self-propelled vehicle uses a more complex method of transmitting a rotation to the front wheels of a vehicle by use of linked levers, rods and rotating steering system parts.

U.S. Pat. No. 7,753,386 B2 is a self-propelled vehicle which uses a cable system in some embodiments. Steering of the front wheel is accomplished but either rotating a handlebar system or use of connected foot levers.

U.S. Pat. No. 7,066,480 is a system for controlling a self-propelled moving part, steering system for a light vehicle and tricycle. While this system uses cables, it is more complex and requires the rotation of handles which are not independent.

Accordingly, there exists a need for a simple front wheel steering device that will facilitate the attendant steering of a wheeled vehicle.

### SUMMARY OF THE INVENTION

Our invention is a means of steering a front wheel of a wheeled device using independent levers, one lever to turn a front wheel right and one lever to turn left. Our invention allows for increased attendant efficiency and reduced effort when travelling a route with turns.

### DESCRIPTION OF THE DRAWINGS

FIG. 1 is a perspective view of the invention showing in this embodiment a wheelchair with a front wheel.

FIG. 2 is a top plan view showing the steering mechanism with the seat removed.

FIG. 3 is a top plan view showing the steering mechanism with the detail of the front end of the vehicle.

### DRAWING PART NOMENCLATURE

1: Handlebar rigidly attached to (8) frame.

2: Two handlebar levers. Two levers mounted on (1) handlebars, one left and one right.

3: Two steering cables wires. Each attached to a (2) lever and (6) spring.

4: Two cable wire housings which guide (3) cable wires.

5: Two Barrel adjustment bolts with lock nuts used to adjust tension in (6) springs.

6: Two Tension springs each connected to a (3) cable wire and the (15) cross bar.

8: Wheeled vehicle frame.

9: Seat attached to (8) frame. Attended person sits in seat.

10: Two back wheels with axels attached to (8) frame.

11: Two foot rests attached to (8) frame for attended person.

14: Front wheel fork.

15: Cross bar rigidly attached to (14) fork frame to attach (6) tension springs to each side.

16: Front wheel attached to (14) fork.

### DETAILED DESCRIPTION OF THE INVENTION

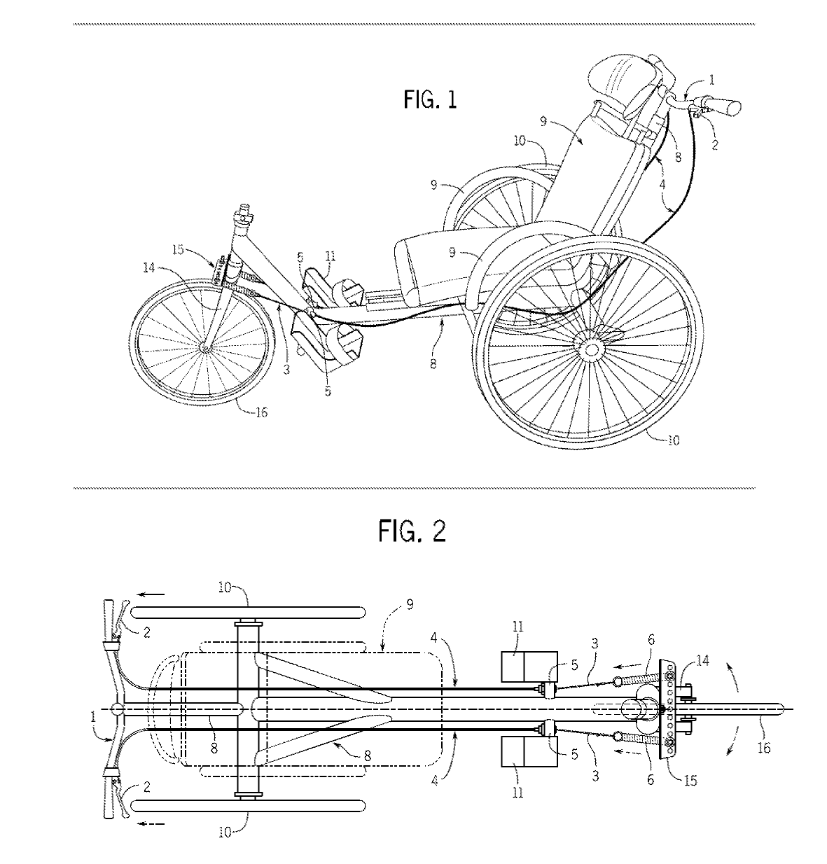

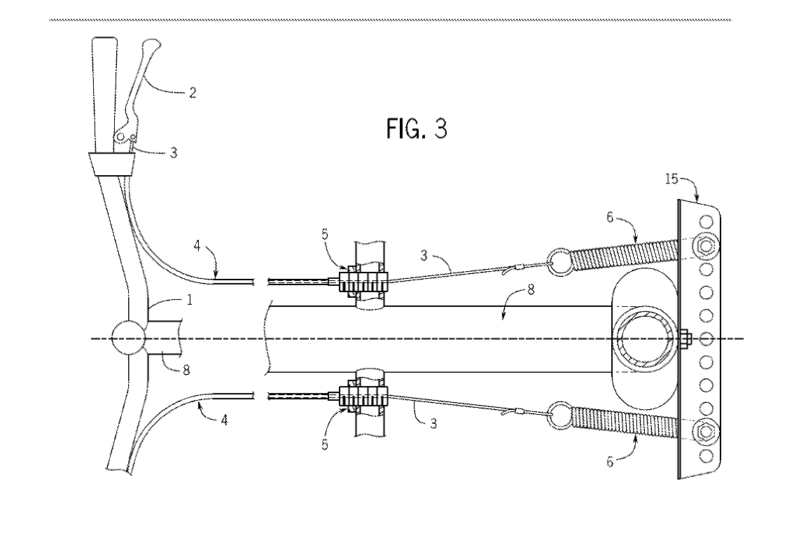

FIGS. 1 through 3 show an embodiment of the invention. The front wheel (16) is turned in one direction by squeezing one handle bar lever (2) and turned the other direction by squeezing the other handlebar lever (2). The turning force is transmitted from the handlebar lever (2) to the front wheel (16) follows: a cable wire (3) is pulled when the handlebar lever (2) is squeezed, the cable wire (3) pulls on the tension spring (6) which in turn pulls on one side of the front fork cross bar (15), the front fork cross bar (15) turns the front wheel fork frame (14) and front wheel (16) in one direction. Squeezing the other handle bar lever (2) pulls another cable wire (3) which is attached to the opposite side of the front fork cross bar(15) and turns the front wheel fork frame (14) the other direction.

When one handlebar lever (2) is pulled, both tension springs (6) are increased in length by about ½ of the amount of cable wire (3) which is pulled by the handlebar lever (2). To steer straight with no squeezing of either handlebar lever (2), it is necessary for the front wheel (16) to be straight. For the front wheel (16) to be straight, there needs to be equal tension on each of the tension springs (6). The tension of the tension springs (6) is adjusted first by positioning of the cable wire clamps (7) to tension the tension springs about the same. Fine tuning of the tension in the tension springs (6) is accomplished by adjustment of the barrel adjustment bolts (5). The barrel adjustment bolts (5) increase the tension in the tension springs (6) when rotated to unscrew from the terminal plate (13) by increasing the length the cable wire (3) must travel from the handlebar lever (2) to the end of the terminal plate (13). A seat (9) and foot rests (11) are attached to the frame (8) which allows the attended person to be pushed by an attendant pushing on the handlebars (1) and steering using the handlebar levers (2).

In an embodiment which is not shown, the distance of cable movement at the front wheel can be increased by use of an elliptical pulley wheel mounted between a lever (2) and spring (6). With a cable attached to the lever (2) pulling on the minor radius of the ellipse and the spring (6) being attached to the major radius of the ellipse, the amount of cable movement/spring extension/front wheel rotation is increased by the ratio of the major to minor radius.

The steering system is manufactured with off the shelf components (For example bicycle brake levers, brake cables and cables housings, bicycle fittings and standard springs.) The rest of the wheeled vehicles can be manufactured similar to the manufacture of other similar wheeled vehicles.

The invention is claimed as follows:

1. (canceled)

2. (canceled)

3. A steering apparatus consisting of levers, cables, springs and front wheel assembly as shown in FIG. 1-3 allowing an attendant to steer the front wheel assembly of a wheeled vehicle by squeezing a lever while the attendant behind the vehicle simultaneously pushes the vehicle in a forward direction.

4. The steering apparatus of claim 3, which includes connection to a wheeled vehicle consisting of a handlebar, rigid frame with fixed passenger seat, cable sheathes (housing), cable sheath attachments, and two non-steerable rear wheels.

5. The steering apparatus of claim 3, which includes a front wheel assembly comprised of a front fork cross bar, front wheel fork frame and front wheel whose axel is attached to the fork frame wherein the front wheel assembly is attached to the rigid frame by bearings which allow the front wheel assembly to rotate in essentially the horizontal plane relative to the vehicle frame.

6. The steering apparatus of claim 3, wherein an attendant applies a force to a lever on either side of a handlebar fixed to a frame to move the lever from a position further away from the handlebar to a position closer to the handle bar, e.g. attendant squeezes the lever toward the handle bar.

7. The steering apparatus of claim 6, wherein the lever movement translates a cable inside a cable sheath toward the depressed lever.

8. The steering apparatus of claim 7, wherein the translated cable is inside a cable sheath fixed to the rigid frame so that the cable motion is translated relative to the frame.

9. The steering apparatus of claim 8, wherein is attached to the translating cable on one end and to the front fork cross bar on the other end.

10. The steering apparatus of claim 9, wherein this cable motion is translated away from a spring attached to the translating cable thus extending the spring.

11. The steering apparatus of claim 10, wherein the spring attached to the translating cable pulls the front fork cross bar toward the translating cable.

12. The steering apparatus of claim 11, wherein the front wheel fork frame rotates in an essentially horizontal plane and applies this rotation to a front wheel which is attached to the front wheel fork frame.

13. The steering apparatus of claim 12, wherein the rotation essentially about the horizontal plane of the front wheel results in a change in direction of the vehicle (a.k.a. steering) when the vehicle is being pushed by the attendant in a forward direction.

14. The steering apparatus of claim 12, wherein the rotation of the front wheel fork frame also elongates a spring attached to the other side of a front wheel cross bar; this elongated spring on the other side is attached to a cable which does not translate relative to the frame as the handlebar lever attached to this other cable is not depressed.

15. The steering apparatus of claim 3, wherein the front and rear wheels are allowed to rotate freely about axels in a vertical plane while the attendant is propelling the vehicle forward.

16. The steering apparatus of claim 3, wherein only one handlebar lever is squeezed at a time to effect steering. When a handlebar lever on only one side is squeezed, the front wheel and vehicle turns in the direction of the handlebar lever. When only the lever on the other side of the handle bar is squeezed, the front wheel turns in the other direction.
